(19) United States
(12) Patent Application Publication
(10) Pub. No.: US 2025/0379249 A1
(43) Pub. Date: Dec. 11, 2025

(54) APPARATUS AND METHOD FOR PRESSURIZING BATTERY

(71) Applicant: SAMSUNG SDI CO., LTD., Yongin-si (KR)

(72) Inventor: Hyunjun Shin, Yongin-si (KR)

(21) Appl. No.: 19/170,948

(22) Filed: Apr. 4, 2025

(30) Foreign Application Priority Data
Jun. 7, 2024 (KR) 10-2024-0074472

(51) Int. Cl. H01M 10/04; B30B 15/00; B30B 15/06

(52) U.S. Cl. CPC H01M 10/0481; B30B 15/0029; B30B 15/061

(57) ABSTRACT

An apparatus for pressurizing a battery includes: a plurality of pressurization plates configured to pressurize a plurality of battery cells interposed between the pressurization plates; a buffering pad interposed between one of the pressurization plates and one of the battery cells, the buffering pad comprising foamed silicon; and a pressure adjustment part configured to adjust pressure between the pressurization plates by adjusting a distance between the pressurization plates.

### CROSS-REFERENCE TO RELATED APPLICATION

The present application claims priority to and the benefit of Korean Patent Application No. 10-2024-0074472, filed on Jun. 7, 2024, in the Korean Intellectual Property Office, the entire disclosure of which is incorporated herein by reference.

### BACKGROUND

### 1. Field

Aspects of embodiments of the present disclosure relate to an apparatus and method for pressurizing a battery.

### 2. Description of the Related Art

Different from primary batteries, which are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery generally includes an electrode assembly including (or consisting of) a positive electrode and a negative electrode, a case accommodating the electrode assembly, a terminal connected to the electrode assembly, etc.

From among the various types of secondary batteries, a pouch type secondary battery is in high demand because it exhibits high energy density and good discharge voltage and output stability. A process of manufacturing of the pouch type secondary battery generally includes pole plating, winding, assembly, and an activation process. The activation process includes a heater press charge (HPC) process to activate the battery by heating, compressing, and charging a battery cell. In the HPC process, when the battery cell is pressed, the battery cell should be uniformly pressurized. However, it is difficult to uniformly pressurize the battery cell due to a difference in the flatness of a battery assembly depending on a structure of the battery assembly included in the battery cell.

The above information disclosed in this Background section is for enhancement of understanding of the background of the present disclosure, and therefore, it may contain information that does not constitute related (or prior) art.

### SUMMARY

Various embodiments of the present disclosure provide an apparatus for pressurizing a battery and a method of pressurizing a battery in which a buffering pad including foamed silicon is interposed between a plurality of pressurization plates and a plurality of battery cells to be pressurized.

However, aspects and features of the present disclosure are not limited to those described above, and other aspects and features not mentioned herein, will be clearly understood by those skilled in the art from the description of the present disclosure below.

An apparatus for pressurizing a battery, according to an embodiment of the present disclosure, includes a plurality of pressurization plates configured to pressurize a plurality of battery cells interposed between the pressurization plates, a buffering pad interposed between one of the the pressurization plates and one of the battery cells and including foamed silicon, and a pressure adjustment part configured to adjust pressure between the pressurization plates by adjusting a distance between the pressurization plates.

The thickness of the foamed silicon of the buffering pad may be 5 mm.

A hardness of the foamed silicon of the buffering pad may be in a range of 20 to 40 on the Shore 00 hardness scale.

The buffering pad may further include common silicon. The foamed silicon may contact the battery cell. The common silicon may contact the pressurization plate.

The thickness of the foamed silicon may be 3 mm. The thickness of the common silicon may be 2 mm.

A hardness of the foamed silicon may be in a range of 20 to 40 on the Shore 00 hardness scale. A hardness of the common silicon may be in a range of 50 to 70 on the Shore 00 hardness scale.

The buffering pad may have a wider area than the battery cells.

The pressure adjustment part may include a plurality of guide parts configured to guide a pressurization direction of the pressurization plates and a pressurization part configured to move the pressurization plates in the pressurization direction to pressurize the battery cells.

The battery cells may be pouch type secondary batteries.

A method of pressurizing a battery, according to an embodiment of the present disclosure, may include providing a plurality of pressurization plates, providing a plurality of battery cells, providing a buffering pad including foamed silicon, interposing the buffering pad between one of the pressurization plates and one of the battery cells, pressurizing the pressurization plates with the plurality of battery cells interposed between the pressurization plates in a state in which the buffering pad is interposed between the one of the battery cells and the one of the pressurization plates, and adjusting pressure between the pressurization plates by adjusting a distance between the pressurization plates.

The foamed silicon of the buffering pad may have a thickness of 5 mm.

The foamed silicon of the buffering pad may have a thickness of 5 mm and may have a hardness in a range of 20 to 40 on the Shore 00 hardness scale.

The buffering pad may further include common silicon. The interposing of the buffering pad between the one of the pressurization plates and the one of the battery cells may include interposing the buffering pad between the one of the pressurization plates and the one of the battery cells such that the foamed silicon contacts the battery cell and the common silicon contacts the pressurization plate.

The foamed silicon of the buffering pad may have a thickness of 3 mm, and the common silicon may have a thickness of 2 mm.

The foamed silicon of the buffering pad may have a hardness in a range of 20 to 40 on the Shore 00 hardness scale, and the common silicon may have a hardness in a range of 50 to 70 on the Shore 00 hardness scale.

The buffering pad may have a wider area than the battery cells.

The pressurizing of the pressurization plates may include pressurizing the pressurization plates through a pressurization part in a pressurization direction that is guided by a plurality of guide parts.

A battery module, according to an embodiment of the present disclosure, includes a battery cell that is pressed by the method of pressurizing a battery described above and a case accommodating the battery cell.

According to embodiments of the present disclosure, pressurization uniformity for a plurality of battery cells can be improved by interposing the buffering pad including foamed silicon between the pressurization plates and pressurizing the battery cells.

According to embodiments of the present disclosure, a reduction in the lifespan of a battery attributable to poor bonding and separation of the separator and an increase in the thickness of the battery can be prevented because the adhesion of the separator can be prevented from failing (or from separating) due to a thickness difference attributable to a difference in the flatness of a battery assembly.

However, aspects and features of the present disclosure are not limited to those described above, and other aspects and features not expressly mentioned will be clearly understood by a person skilled in the art from the detailed description that follows.

### BRIEF DESCRIPTION OF THE DRAWINGS

The following drawings attached to this specification illustrate embodiments of the present disclosure and further describe the technical spirit of the present disclosure along with the aforementioned and hereinafter described contents of the disclosure. Accordingly, the present disclosure should not be construed as being limited to the content described in such drawings, in which:

FIG. 1A is a perspective view a pouch type secondary battery according to an embodiment.

FIG. 1B is a perspective view of a pouch type secondary battery according to another embodiment.

FIG. 2 is a cross-sectional view of a battery assembly of a pouch type secondary battery.

FIG. 3 is a perspective view of an apparatus for pressurizing a battery according to an embodiment of the present disclosure.

FIG. 4 is a diagram illustrating a pressurization plate and buffering pad of the apparatus for pressurizing a battery shown in FIG. 3.

FIG. 5 is a diagram illustrating a buffering pad of the apparatus for pressurizing a battery shown in FIG. 3.

FIG. 6 includes photographs showing experimental examples in which a case in which a battery cell was pressed by a conventional apparatus for pressurizing a battery and a case in which a battery cell was pressed by an apparatus for pressurizing a battery according to embodiments of the present disclosure are compared.

FIG. 7 is a flowchart describing steps of a method of pressurizing a battery according to an embodiment of the present disclosure.

### DETAILED DESCRIPTION

Embodiments of the present disclosure will be described below, in detail, with reference to the accompanying drawings. The terms or words used in this specification and claims should not be construed as being limited to their common or dictionary meanings but instead should be understood to have meanings and concepts consistent with the spirit of the present disclosure based on the principle that an inventor can define the concept of each term suitably in order to describe his/her own invention in the best way possible. Further, because the embodiments described in this specification and the configurations illustrated in the drawings are only some embodiments of the present disclosure such that do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

To facilitate understanding of the present disclosure, the accompanying drawings may not be drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of about 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is basically applicable to a pouch type secondary battery. Therefore, the pouch type secondary battery will be briefly described prior to description of embodiments of the present disclosure.

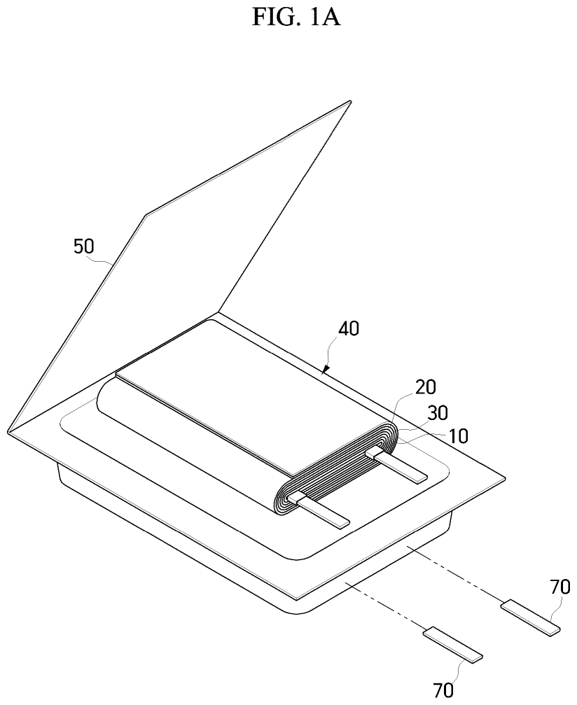

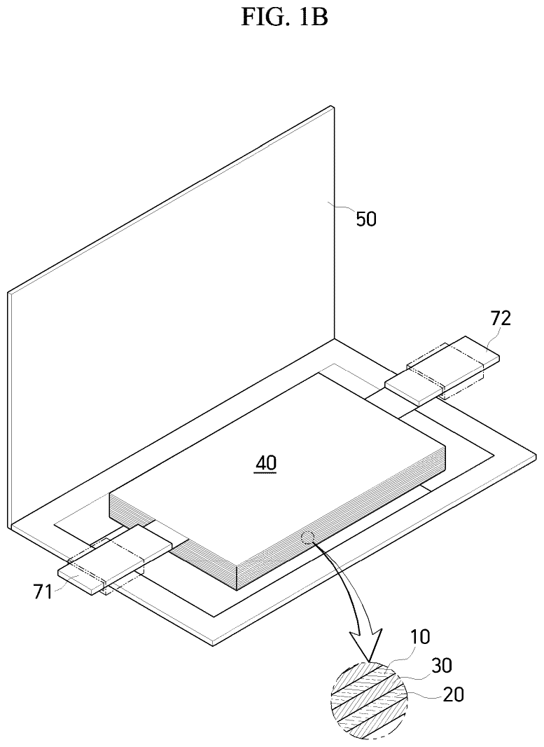

FIG. 1A illustrates an example of pouch type secondary battery. FIG. 1B illustrates another example of pouch type secondary battery.

Referring to FIG. 1A and FIG. 1B, a pouch type secondary battery may include an electrode assembly 40 in which a separator 30 is interposed between a first electrode plate 10 and a second electrode plate 20 and a case 50 in which the electrode assembly 40 is accommodated (or embedded). The first electrode plate 10, the second electrode plate 20, and the separator 30 may be impregnated in an electrolyte. The pouch type secondary battery may include an electrode tab 70 that provides an electrical passage for inducing a current formed in the electrode assembly 40 toward the outside. The electrode tab 70 may include a first electrode tab 71 and a second electrode tab 72.

The electrode assembly 40 may be formed by winding or stacking a stack including the first electrode plate 10, the second electrode plate 20, and the separator 30, each of which is formed having a plate or film shape. In the case of the winding stack body, the winding axis of the electrode assembly 40 may be parallel to the length direction of the case. Furthermore, the electrode assembly 40 may be the stack type, but a shape of the electrode assembly 40 is not limited in the present disclosure. The first electrode plate 10 of the electrode assembly 40 may be a positive electrode, and the second electrode plate 20 thereof may be a negative electrode, but the reverse is also possible.

The first electrode plate 10 may be formed by applying a first electrode active material, such as graphite or carbon, to a first electrode collector plate formed of a metal foil, such as copper, a copper alloy, nickel, or a nickel alloy. The first electrode plate 10 may include a first electrode tab (e.g., a first uncoated part), that is, an area of the first electrode collector plate at where the first electrode active material is not applied.

The second electrode plate 20 may be formed by applying a second electrode active material, such as a transition metal oxide, to a material formed of a metal foil, such as aluminum or an aluminum alloy. The second electrode plate 20 may include a second electrode tab (e.g., a second uncoated part), that is, an area of the second electrode collector plate at where the second electrode active material is not applied.

The separator 30 may prevent a short-circuit between the first electrode plate 10 and the second electrode plate 20 while permitting a movement of lithium ions therebetween. The separator 30 may include (or may be composed of) a polyethylene film, a polypropylene film, or a polyethylene-polypropylene film, as some examples.

The case 50 may be a laminate film or may be a plastic material, as a pouch type. The case 50 is sealed at the sealing portions along the edges contacting each other while accommodating the electrode assembly 40. The sealing of the case 50 is performed with the electrode tab 70, or the positive electrode tab 71 and the negative electrode tab 72, placed between the sealing portions. The sealing portion of the case 50 is made of a heat-melting material and has a structure in which sealing is achieved by bonding heat-melting layers to each other.

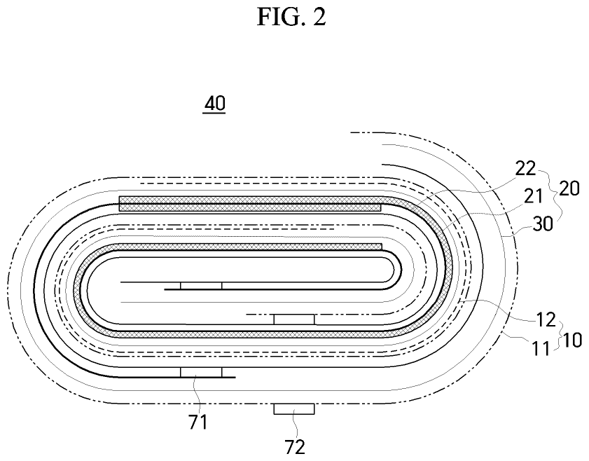

FIG. 2 is a cross-sectional view of a battery assembly of the pouch type secondary battery.

Referring to FIG. 2, an electrode assembly 40 of the pouch type secondary battery may be formed by being wound in a jelly roll form. The electrode assembly 40 may include a first electrode base 11, a first electrode mixture 12, a second electrode base 21, a second electrode mixture 22, a separator 30, a positive electrode tab 71, and a negative electrode tab 72. The first electrode base 11 and the first electrode mixture 12 may constitute the first electrode plate 10. The second electrode base 21 and the second electrode mixture 22 may constitute the second electrode plate 20.

The flatness of the electrode assembly 40 varies depending on a structure design of the electrode assembly 40. For example, as illustrated in FIG. 2, a thickness difference occurs between the electrode plates 10, 20 depending on a coating part/uncoated part of the electrode plates 10, 20 or based on an area at where a tape is overlapped. As the thickness difference increases, the adhesion of the separator at a corresponding portion is separated when compression at a high temperature is performed in a heater press charge (HPC) process. When the adhesion of the separator at a local location is separated (or fails), additional reactants are generated and accumulated when charging and discharging are performed. As the distance between pole plates is continuously increased, the lifespan of a battery is reduced and the thickness of the battery is increased due to precipitation and non-charging.

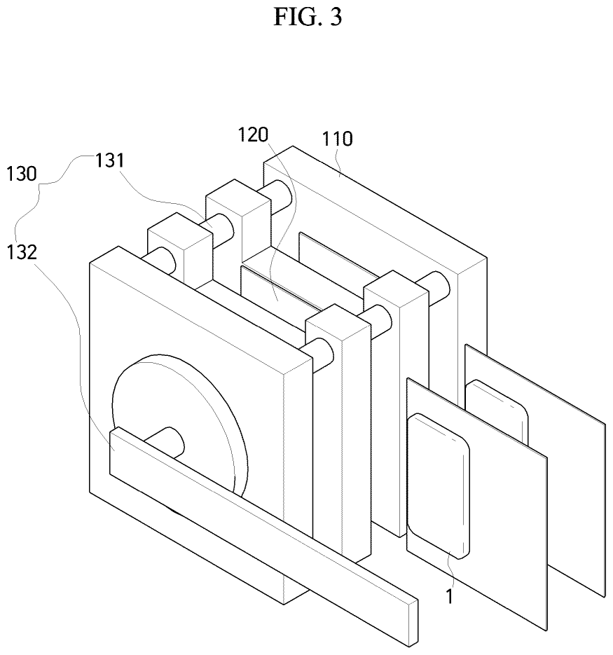

FIG. 3 is a perspective view of an apparatus for pressurizing a battery according to an embodiment of the present disclosure.

Referring to FIG. 3, an apparatus for pressurizing a battery according to embodiments of the present disclosure may include a plurality of pressurization plates 110, a buffering pad 120, and a pressure adjustment part 130.

The plurality of pressurization plates 110 are pressed together with a plurality of battery cells 1 interposed therebetween. The pressurization plate 110 may heat and pressurize the battery cells 1 in a HPC process. In various embodiments, the pressurization plate 110 transfers pressure to the battery cells 1 through the buffering pad 120. The pressurization plate 110 may be made of a rigid metal material (e.g., a metal material exhibiting limited bending) to effectively transfer pressure to the battery cells 1. For example, the pressurization plate 110 may be made of an aluminum alloy.

The buffering pad 120 is interposed between the pressurization plate 110 and the battery cell 1. The buffering pad may have a wider area (e.g., a wider surface area) than the battery cell 1. In various embodiments, the buffering pad 120 may include foamed silicon. The foamed silicon is silicon that is manufactured by a foaming method. The foamed silicon has multiple empty spaces formed therein and exhibits an improved restoring force and elastic force than common silicon. When the pressurization plate 110 presses the battery cells 1, the battery cells 1 are pressurized by the buffering pad 120. Accordingly, the battery cells 1 can be uniformly pressed because a thickness difference attributable to a structure of a battery assembly in the battery cell 1 is filled by the internal empty space of the foamed silicon.

In various embodiments, the thickness of the foamed silicon may be about 5 mm. When the thickness of the foamed silicon is smaller than about 5 mm, the battery cell 1 may not be uniformly pressurized because the internal empty space in the foamed silicon is insufficient. Furthermore, the hardness of the foamed silicon may be in a range of about 20 to about 40 on the Shore 00 hardness scale. When the hardness of the foamed silicon is smaller than about 20 on the Shore 00 hardness scale, it is difficult to apply a sufficient force to the battery cell 1 such that it is compressed. When the hardness of the foamed silicon is greater than about 40 on the Shore 00 hardness scale, a thickness difference between the battery cells 1 that can be filled may be reduced.

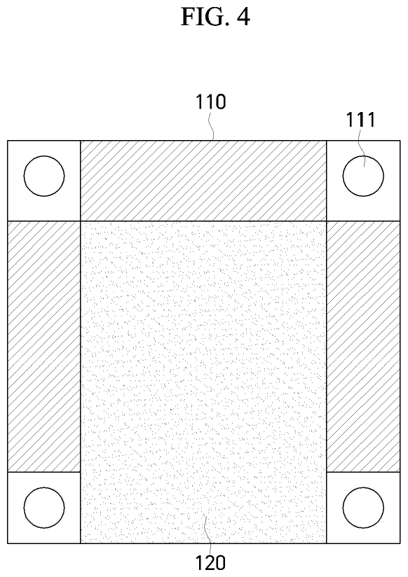

FIG. 4 is a diagram illustrating the pressurization plate and buffering pad of the apparatus for pressurizing a battery according to an embodiment of the present disclosure.

FIG. 4 illustrates the pressurization plate 110 and buffering pad 120 of the apparatus 100 for pressurizing a battery according to embodiments of the present disclosure. A plurality of guide holes (e.g., guide openings) 111, into which a guide part 131 will be respectively inserted, may be formed in the pressurization plate 110. The diameter of the guide hole 111 may be formed to be slightly greater than the diameter of the guide bar 131 so that the pressurization plate 110 can move along the guide bar 131.

In various embodiments, the pressurization plate 110 may have a wider area (e.g., a wider surface area) than the buffering pad 120. The buffering pad 120 may be formed within an area in which the guide holes 111 of the pressurization plate 110 have been formed.

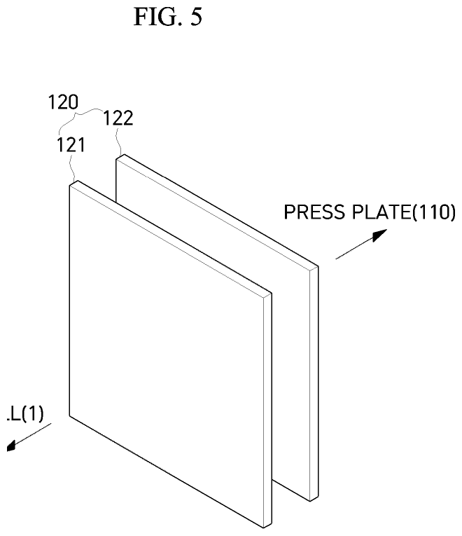

The buffering pad 120 may be formed to have a dual structure including foamed silicon and common silicon. The buffering pad 120 having the dual structure is described below with reference to FIG. 5.

FIG. 5 is a diagram illustrating the buffering pad of the apparatus for pressurizing a battery according to embodiments of the present disclosure.

Referring to FIG. 5, the buffering pad 120 of the apparatus 100 for pressurizing a battery according to embodiments of the present disclosure may include foamed silicon 121 and common silicon 122. Common silicon, as used herein, refers to silicon that is manufacturing by a common method without performing a foaming method. In various embodiments, the foamed silicon 121 may contact the battery cell 1, and the common silicon 122 may contact the pressurization plate 110. The foamed silicon is relatively more expensive than the common silicon. Accordingly, to uniformly pressurize the battery cell 1 and to reduce a manufacturing cost of a battery, the foamed silicon 121 having a good restoring force and elasticity is used in a portion of the buffering pad 120 that comes into contact with the battery cell 1 while the common silicon 122 having a poorer restoring force and elasticity than the foamed silicon 121 is used in a portion of the buffering pad 120 that comes into contact with the pressurization plate 110.

In various embodiments, the thickness of the foamed silicon 121 may be about 3 mm, and the thickness of the common silicon 122 may be about 2 mm. When the thickness of the foamed silicon 121 is smaller than about 3 mm, the battery cell 1 may not be uniformly pressurized because the internal empty space is insufficient. Furthermore, the hardness of the foamed silicon 121 may be in a range of about 20 to about 40 on the Shore 00 hardness scale, and the hardness of the common silicon 122 may be in a range of about 50 to about 70 on the Shore 00 hardness scale. When the hardness of the foamed silicon 121 is smaller than about 20 on the Shore 00 hardness scale, a force sufficient to compress the battery cell 1 may not be sufficiently provided. When the hardness of the foamed silicon 121 is greater than about 40 on the Shore 00 hardness scale, an ability to file the difference in the thickness of the battery cells 1 may be reduced.

Referring back to FIG. 3, the pressure adjustment part 130 is configured to adjust pressure between the plurality of pressurization plates 110 by adjusting a distance between the plurality of pressurization plates 110. In various embodiments, the pressure adjustment part 130 may include the plurality of guide parts 131 and a pressurization part 132.

The plurality of guide parts 131 provides guides the pressurization direction of the pressurization plate 110. In various embodiments, the guide part 131 is inserted into the guide hole 111 of the pressurization plate 110 and may guide the pressurization direction of the pressurization plate 110.

The pressurization part 132 moves the pressurization plate 110 in a pressurization direction and is guided by the plurality of guide parts 131 to press the pressurization plate 110. In various embodiments, the pressurization part 132 may move the pressurization plate 110 by being rotated manually or automatically.

According to embodiments of the present disclosure, pressurization uniformity for the plurality of battery cells 1 can be improved by interposing the buffering pad 120 including foamed silicon between the plurality of pressurization plates 110 and pressurizing the plurality of battery cells 1,

According to embodiments of the present disclosure, a reduction in the lifespan of a battery attributable to the bonding and separation of the separator and an increase in the thickness of the battery can be prevented because the adhesion of the separator can be prevented from failing (or from being separated) due to a thickness difference attributable to a difference in the flatness of a battery assembly.

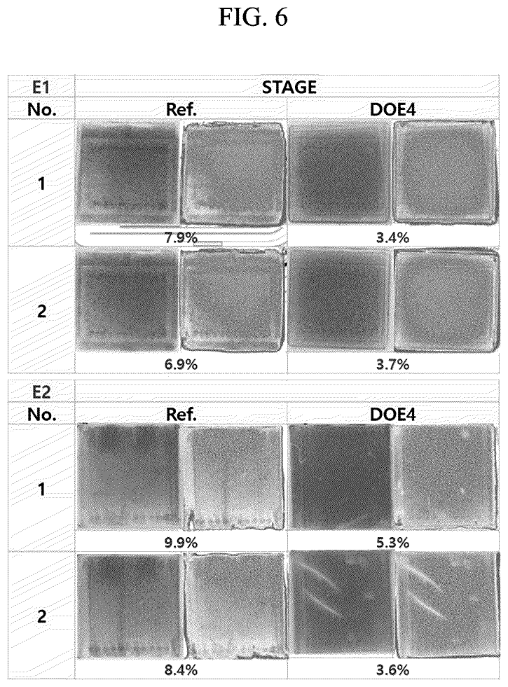

FIG. 6 shows photographs of experimental examples in which a battery cell was pressed by a conventional apparatus for pressurizing a battery and in which a battery cell was pressed by the apparatus for pressurizing a battery according to embodiments of the present disclosure were compared.

Referring to FIG. 6, the left (Ref.) illustrates the results of decompression paper tests in the case where the battery cell was pressed by the conventional apparatus for pressurizing a battery. The right (DOE4) illustrates the results of decompression paper tests in the case where the battery cell was pressed by the apparatus for pressurizing a battery according to embodiments of the present disclosure.

Referring to the left (Ref.), pressure was not uniformly applied to the battery cell; instead pressure was excessively applied to some parts of the battery cell as shown as the bright portion at an upper part of the battery cell when the battery cell was pressed by the conventional apparatus for pressurizing a battery.

Referring to the right (DOE4), pressure was uniformly applied to the battery cell because a bright portion and a dark portion are uniformly spread across the battery cell when the battery cell was pressed by the apparatus for pressurizing a battery according to embodiments of the present disclosure.

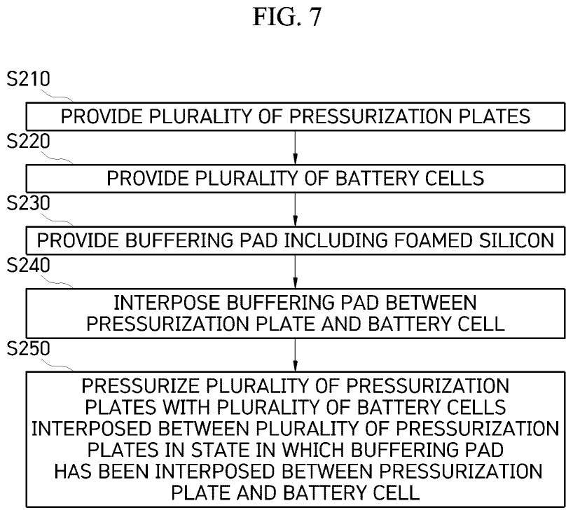

FIG. 7 is a flowchart describing steps of a method of pressurizing a battery according to embodiments of the present disclosure.

As illustrated in FIG. 7, the method of pressurizing a battery according to embodiments of the present disclosure may include steps S210 to S250.

Step S210 is a step of providing the plurality of pressurization plates.

Step S220 is a step of providing the plurality of battery cells.

Step S230 is a step of providing the buffering pad including the foamed silicon. In various embodiments, step S230 may include a step of providing the buffering pad including the foamed silicon having a thickness of about 5 mm. In such an embodiment, step S230 may include a step of providing the buffering pad including the foamed silicon having hardness in a range of about 20 to about 40 on the Shore 00 hardness scale.

In another embodiment, step S230 may include a step of providing the buffering pad including the foamed silicon and common silicon. In such an embodiment, step S230 may include a step of providing the buffering pad including the foamed silicon having a thickness of about 3 mm and a hardness in a range of about 20 to about 40 on the Shore 00 hardness scale and the common silicon having a thickness of about 2 mm and having a hardness in a range of about 50 to about 70 on the Shore 00 hardness scale.

In another embodiment, step S230 may include a step of providing the buffering pad having a wider area than the battery cell.

Step S240 is a step of interposing the buffering pad between the pressurization plate and the battery cell. In various embodiments, step S240 may include a step of interposing the buffering pad between the pressurization plate and the battery cell so that the foamed silicon contacts the battery cell and the common silicon contacts the pressurization plate.

Step S250 is a step of pressurizing the plurality of battery cells through the plurality of pressurization plates with the plurality of battery cells interposed between plurality of pressurization plates in the state in which the buffering pad has been interposed between the pressurization plate and the battery cell. In various embodiments, step S250 may include a step of pressurizing the pressurization plate through the pressurization part in a pressurization direction that is guided by the plurality of guide parts.

A battery cell that is pressed by the method of pressurizing a battery according to embodiments of the present disclosure may constitute a battery module by being combined with a case that accommodates the battery cell.

The method of pressurizing a battery according to embodiments of the present disclosure has been described with reference to the flowchart presented in the drawings. For a simple description, the method has been illustrated and described as a series of steps, but the present disclosure is not limited to the sequence of steps as illustrated, and some steps may be performed in a sequence different from or concurrently with (or simultaneously with) that of other steps that have been illustrated and described in this specification. Various other branches, flow paths, and sequences of steps that achieve the same or similar results may be implemented. Furthermore, one or more of the steps illustrated to implement the method described in this specification may be omitted.

In the description provided with reference to FIG. 7, each of the steps may be further divided into additional steps or the steps may be combined into smaller steps depending on an implementation embodiment of the present disclosure. Furthermore, some of the steps may be omitted, and the sequence of steps may be changed. Furthermore, the content of FIGS. 1A to 6 may be applied to the content of FIG. 7. Furthermore, the content of FIG. 7 may be applied to the content of FIGS. 1A to 6.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}Dα (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

Although the present disclosure has been described above in connection with certain embodiments, the present disclosure is not limited to the described embodiments. A person having ordinary knowledge in the art to which the present disclosure pertains may modify and change the present disclosure within the technical spirit of the present disclosure and the equivalent range of the following claims.

### DESCRIPTION OF SOME REFERENCE NUMERALS

100: apparatus for pressurizing battery
110: pressurization plate 111: guide hole
120: buffering pad 121: foamed silicon
122: common silicon 130: pressure adjustment part
131: guide part 132: pressurization part

What is claimed is:

1. An apparatus for pressurizing a battery, the apparatus comprising:
a plurality of pressurization plates configured to pressurize a plurality of battery cells interposed between the pressurization plates;
a buffering pad interposed between one of the pressurization plates and one of the battery cells, the buffering pad comprising foamed silicon; and
a pressure adjustment part configured to adjust pressure between the pressurization plates by adjusting a distance between the pressurization plates.

2. The apparatus as claimed in claim 1, wherein a thickness of the foamed silicon of the buffering pad is 5 mm.

3. The apparatus as claimed in claim 2, wherein a hardness of the foamed silicon of the buffering pad is in a range of 20 to 40 on the Shore 00 hardness scale.

4. The apparatus as claimed in claim 1, wherein the buffering pad further comprises common silicon,
wherein the foamed silicon contacts the one of the battery cells, and
wherein the common silicon contacts the one of the pressurization plates.

5. The apparatus as claimed in claim 4, wherein a thickness of the foamed silicon is 3 mm, and
wherein a thickness of the common silicon is 2 mm.

6. The apparatus as claimed in claim 5, wherein a hardness of the foamed silicon is in a range of 20 to 40 on the Shore 00 hardness scale, and
wherein a hardness of the common silicon is in a range of 50 to 70 on the Shore 00 hardness scale.

7. The apparatus as claimed in claim 1, wherein the buffering pad has a wider area than the one of the battery cells.

8. The apparatus as claimed in claim 1, wherein the pressure adjustment part comprises:
a plurality of guide parts configured to guide a pressurization direction of the pressurization plates; and
a pressurization part configured to move the pressurization plates in the pressurization direction to pressurize the battery cells.

9. The apparatus as claimed in claim 1, wherein the battery cells are pouch type secondary batteries.

10. A method of pressurizing a battery, the method comprising:
providing a plurality of pressurization plates;
providing a plurality of battery cells;
providing a buffering pad comprising foamed silicon;
interposing the buffering pad between one of the pressurization plates and one of the battery cells;
pressurizing the pressurization plates with the battery cells interposed between the pressurization plates in a state in which the buffering pad is interposed between the one of the battery cells and the one of the pressurization plates; and
adjusting pressure between the pressurization plates by adjusting a distance between the pressurization plates.

11. The method as claimed in claim 10, wherein the foamed silicon of the buffering pad has a thickness of 5 mm.

12. The method as claimed in claim 11, wherein the foamed silicon of the buffering pad has a thickness of 5 mm and a hardness in a range of 20 to 40 on the Shore 00 hardness scale.

13. The method as claimed in claim 10, wherein the providing of the buffering pad comprises providing the buffering pad further comprising common silicon, and
wherein the interposing of the buffering pad between one of the pressurization plates and the one of the battery cells comprises interposing the buffering pad between the one of the pressurization plates and the one of the battery cells such that the foamed silicon contacts the one of the battery cells and the common silicon contacts the one of the pressurization plates.

14. The method as claimed in claim 13, wherein the foamed silicon of the buffering pad has a thickness of 3 mm, and the common silicon of the buffering pad has a thickness of 2 mm.

15. The method as claimed in claim 14, wherein the foamed silicon of the buffer pad has a hardness in a range of 20 to 40 on the Shore 00 hardness scale, and the common silicon of the buffering pad has a hardness in a range of 50 to 70 on the Shore 00 hardness scale.

16. The method as claimed in claim 10, wherein the buffering pad has a wider area than the battery cells.

17. The method as claimed in claim 10, wherein the pressurizing of the pressurization plates comprises pressurizing the pressurization plates through a pressurization part in a pressurization direction that is guided by a plurality of guide parts.

18. A battery module comprising:
a battery cell pressed by the method of pressurizing a battery according to claim 10; and
a case accommodating the battery cell.
